(19) United States
(12) Patent Application Publication
(10) Pub. No.: US 2025/0038536 A1
(43) Pub. Date: Jan. 30, 2025

(54) A METHOD OF CHARGING AN AUXILIARY BATTERY

(71) Applicant: MYENERGI LIMITED, Stallingborough, Lincolnshire (GB)

(72) Inventor: Nina Szamocki-Hoffman, Bristol (GB)

(21) Appl. No.: 18/715,970

(22) PCT Filed: Nov. 30, 2022
(86) PCT No.: PCT/EP2022/083920

§ 371 Date: Jun. 3, 2024

(30) Foreign Application Priority Data
Dec. 1, 2021 (GB) 2117346.3

(51) Int. Cl. H02J 3/32; B60L 53/50; H02J 3/38; H02J 7/34

(52) U.S. Cl. CPC H02J 3/322; B60L 53/50; H02J 3/38; H02J 7/34

(57) ABSTRACT

There is disclosed a method of charging an auxiliary battery with a local renewable power source and an external power source, the method comprising: determining whether there is excess power generated by the local renewable power source, and if there is excess power: directing the excess power to an auxiliary battery charger; if there is no excess power: determining whether a minimum charge threshold of the auxiliary battery has been exceeded, and if the minimum charge threshold has not been exceeded, directing power from an external power source to the auxiliary battery charger.

### TECHNICAL FIELD

The invention relates to a method of charging an auxiliary battery with a local renewable power source and an external power source, and a system, computer readable medium and a computer program for the same.

### BACKGROUND

Renewable energy is known to provide fluctuating power such that its generation cannot always be used immediately and locally. Any unused power will be wasted if it is not stored in batteries or directed to the grid. However, these solutions are not particularly cost or resource efficient since batteries are expensive and the grid requires stepping up and down of voltages and incurs various transmission losses.

### STATEMENTS OF INVENTION

According to a first aspect, there is provided a method of charging an auxiliary battery with a local renewable power source and an external power source, the method comprising: determining whether there is excess renewable power generated by the local renewable power source, and if there is excess renewable power: directing the excess power to an auxiliary battery charger; if there is no excess renewable power: determining whether a minimum charge threshold of the auxiliary battery has been exceeded, and if the minimum charge threshold has not been exceeded, directing power from an external power source to the auxiliary battery charger.

The method may be computer-implemented. Excess renewable power may be power which is generated by the local renewable power source, but which is not used by a local power consuming system, such as power consuming devices in a domestic home, a building, a factory etc.

If the minimum charge threshold has been exceeded, the method may comprise not directing power from the external power source to the auxiliary battery charger.

The minimum charge threshold may be based on a predetermined input from a user. The minimum charge threshold may be dynamically determined.

The method may comprise determining the minimum charge threshold. The predetermined input from a user may relate to one of an upper charge threshold, a minimum required auxiliary battery charge or a minimum amount of charging time.

The minimum charge threshold may be a minimum amount of charging time over a specified time period. The predetermined input from the user may relate to one of an upper charge threshold, a minimum required auxiliary battery charge, or a minimum amount of charging time required by a set time.

Determining the minimum charge threshold may comprise: receiving the predetermined input from the user relating to the minimum required auxiliary battery charge or the upper charge threshold; calculating a potential charge amount which could be added from a current time to the set time, if continuous power from the external power source is directed to the auxiliary battery charger; and subtracting the potential charge amount from the respective minimum required auxiliary battery charge, the upper charge threshold or the minimum amount of charging time to determine the minimum charge threshold.

Determining the minimum charge threshold may comprise: determining expected available excess renewable energy from one or more local renewable power sources up to the set time; and determining the minimum charge threshold based on the expected available excess renewable energy.

Determining the expected available excess renewable energy may comprise: receiving one of a weather forecast, historical data of excess renewable energy or historical data of weather patterns; and determining the expected available excess renewable energy from local renewable sources based on the weather forecast, historical data of excess renewable energy or historical data of weather patterns.

Determining the expected available excess renewable energy may comprise: receiving the weather forecast; determining an expected available renewable energy up to the set time from local renewable power sources based on the weather forecast; determining an expected energy consumption up to the set time; offsetting the expected energy consumption from the expected available renewable energy to determine the expected available excess renewable energy up to the set time.

Determining the minimum charge threshold based on the expected available excess renewable energy may comprise subtracting the expected available excess renewable energy from an upper charge threshold, wherein the expected available excess renewable energy may have the same units as the minimum charge threshold and the upper charge threshold.

Determining the minimum charge threshold based on the expected available excess renewable energy may comprise subtracting the expected available excess renewable energy from the minimum required auxiliary battery charge, or from a charge anticipated to be accumulated over the minimum amount of charging time. The expected available excess renewable energy may have the same units as the minimum required auxiliary battery charge, the minimum charge threshold, and the charge anticipated to be accumulated over the minimum charging time.

For example, the same (i.e. common) units between the available excess renewable energy, the minimum required auxiliary battery charge, the minimum charge threshold, the upper charge threshold and the charge anticipated to be accumulated over the minimum charging time may be in an amount of energy (e.g. kWh) or in the amount of charge (e.g. a percentage of charge of the auxiliary battery).

The method may comprise: determining whether directing power from an external power source to the auxiliary battery charger continually up to the set time will be sufficient to charge the auxiliary battery up to one of the minimum required auxiliary battery charge, the upper charge threshold or the minimum amount of charging time required; and if it is determined that directing power from an external power source to the auxiliary battery charger continually up to the set time will not be sufficient to charge the auxiliary battery up to the respective one of the minimum required auxiliary battery charge, the upper charge threshold, or the minimum required charging time, alerting the user that they may have insufficient charge by the set time to perform their desired function with the respective auxiliary battery.

The auxiliary battery may be an electric vehicle battery, such as an electric car battery, an electric lawnmower battery, or an electric bike battery.

The predetermined input may relate to a required travelling distance, and wherein the required travelling distance corresponds to a minimum required auxiliary battery charge.

The minimum required auxiliary battery charge may be based on the minimum travel distance and typical traffic conditions on the required journey at the set time.

The method may further comprise determining if the auxiliary battery has a battery charge exceeding a maximum charge threshold, and if the battery charge exceeds the maximum charge threshold, and if there is excess renewable power, directing the excess renewable power to an alternative auxiliary battery based on a priority schedule or back to the grid.

The method may comprise: if the minimum charge threshold has been exceeded, monitoring an external power price and if the external power price is below a power price threshold: directing power from the external power source to the auxiliary battery charger; and if the power price is above the power price threshold: not directing power from the grid source to the auxiliary battery charger.

The method may comprise: determining whether power is being drawn from the external power source; and if power is being drawn from the external power source, and if the minimum charge threshold has been exceeded, drawing power from the auxiliary battery in preference to the external power source.

The method may comprise: receiving a priority schedule based on the priority of a plurality of auxiliary batteries, and determining which auxiliary battery to charge based on the priority schedule.

According to a second aspect, there is provided non-transitory computer readable medium comprising computer-readable instructions that, when read by a computer, causes the performance of a method in accordance with the first aspect.

According to a third aspect, there is provided a computer program that, when read by a computer causes the performance of a method in accordance with the first aspect.

According to a fourth aspect, there is provided a system for charging an auxiliary battery, the system comprising: a power distribution unit configured to connect to a local renewable power source and an external power source including a utility grid to receive power; and an auxiliary charger configured to connect to an auxiliary battery to charge the auxiliary battery, wherein the power distribution unit is connected to the auxiliary battery charger to selectively direct power to the auxiliary charger; and a processor and at least one memory comprising computer readable instructions, wherein the processor is configured to read the computer readable instructions, and perform the method according to the first aspect.

Wherein the processor may only perform the method when the auxiliary battery charger is connected to at least one auxiliary battery. There may be a plurality of auxiliary chargers, and the power distribution unit may be configured to connect to each auxiliary charger.

The power distribution unit may comprise a plurality of smart sockets, wherein the processor is configured to determine whether a device, plugged into the respective socket, comprises a battery which requires charging, and wherein the processor is configured to perform the method of the first aspect using each socket as a separate auxiliary charger.

The auxiliary charger may comprise an electric vehicle charger, such as an electric car charger.

### DESCRIPTION OF THE DRAWINGS

Embodiments will now be described, by way of example only, with reference to the following description, and accompanying drawings, in which:

FIG. 1 schematically shows a system for charging an auxiliary battery with local renewable power sources and an external power source;

FIG. 2 is a flowchart showing steps of a method for charging the auxiliary battery in the form of an electric car battery;

FIG. 3 is a flowchart showing steps of a first sub-method for determining a minimum charge threshold;

FIG. 4 is a graph showing a worked example of the charge in an auxiliary battery according to the method in FIG. 2 together with the sub-method in FIG. 3;

FIG. 5 is a flowchart showing steps of a second sub-method for determining a minimum charge threshold;

FIG. 6 is a graph showing a worked example of the charge in an auxiliary battery according to the method in FIG. 2 together with the sub-method in FIG. 5;

FIG. 7 is a flowchart showing steps of a third sub-method for determining a minimum charge threshold;

FIG. 8 is a graph showing a worked example of the charge in an auxiliary battery according to the method in FIG. 2 together with the sub-method in FIG. 7;

FIG. 9 is a flowchart showing steps of a fourth sub-method for determining a minimum charge threshold; and

FIG. 10 is a graph showing a worked example of the charge in an auxiliary battery according to the method in FIG. 2 together with the sub-method in FIG. 9.

### DETAILED DESCRIPTION

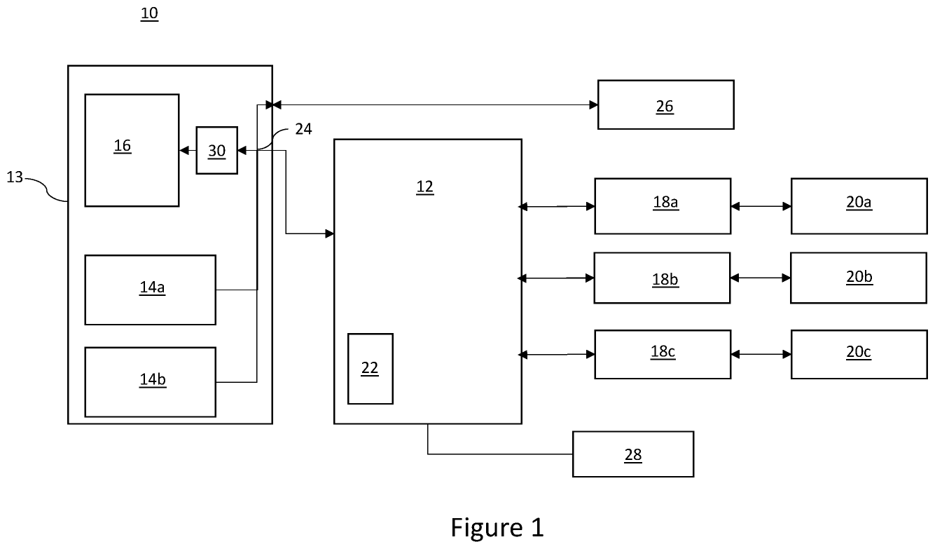

FIG. 1 shows a system 10 for charging a plurality of auxiliary batteries 20a, 20b, 20c with renewable energy from a local renewable power source 14, and energy from an external power source 16. The system 10 may be an electric system for a domestic household, an office space, a factory or other industrial compound, a service station, or any local space configured for use, and having a local renewable energy source which is connected directly to the system, rather than via the utility grid.

The auxiliary batteries 20 are batteries which have a primary function to provide power to an auxiliary device, rather than their function being related solely to providing excess energy storage, such as an indiscriminate battery. In this example, the auxiliary batteries 20 are electric car batteries 20 which have a primary function to power a car. In other examples, the auxiliary battery may be any suitable battery, such as an electric bicycle battery or a battery in any vehicle to power any function in a vehicle, a battery in a phone or other electronics device, a battery in a cordless lawnmower, cordless vacuum cleaner or other domestic device, a battery for powering industrial machinery etc. It will be appreciated that this list of example auxiliary batteries is non-exhaustive.

The system 10 comprises a power distribution unit 12 (PDU) configured to connect to at least one source of power 13 and receive power from the source of power 13. In this example, the source of power 13 comprises two local renewable power sources 14a, 14b. In other examples, the source of power may comprise any number of local renewable power sources, such as only a single local renewable power source, or more than two.

In this example, the power source 13 comprises a series of connected photovoltaic solar panels 14a and a wind power source 14b. In other examples, the PDU may be connected to any number and type of local renewable power sources.

The power source 13 also comprises an external power source 16. In this example, the external power source is a utility grid power source 16 (hereinafter referred to as the “grid”). In other examples, the external power source may be a generator or any other suitable power source which is not reliant on local renewable power sources. Therefore, it will be appreciated that any reference to the grid in the foregoing description may be replaced with any other external power source.

In this example, the local renewable power sources 14 are connected to the grid 16, and are configured to direct power to the grid 16, as necessary.

The PDU 12 is configured to receive power from each of the local renewable power sources 14 and from the grid 16 via a single connection. In other examples, each power source may be individually connected to the PDU through their own respective inputs, and configured to send and/or receive power from the PDU individually. In this example the PDU 12 is also configured to send power to the grid 16 via the single connection. In other examples, the PDU may be configured only to receive power from the grid 16, and not to send power to the grid 16. There may be any suitable means employed for preventing power being sent to the local renewable sources, such as diodes or controlled switches or any other components configured to ensure that electric flow is only one-way.

The system 10 further comprises three auxiliary chargers 18a, 18b, 18c, each of which is configured to connect to a respective electric car battery 20a, 20b, 20c to charge the respective electric car battery. In other examples, the system may comprise only one auxiliary charger, two auxiliary chargers or more than three auxiliary chargers to connect to respective auxiliary batteries to charge the respective auxiliary batteries. It will be appreciated that there may be only a single auxiliary charger, which is configured to connect to a plurality of auxiliary batteries to charge each of the auxiliary batteries, and that there may be any suitable number of auxiliary batteries 20.

The PDU 12 is configured to send and receive power from each of the auxiliary chargers 18. In other examples, the PDU may be configured only to send power to some or all of the auxiliary chargers. The PDU 12 is therefore configured to selectively direct power to each auxiliary charger 18 and to selectively receive or draw power from each auxiliary charger 18.

The PDU 12 comprises a processor 22 configured to control the selective directing of power to each of the auxiliary batteries 20 via auxiliary chargers 18 to charge the respective auxiliary batteries 20, and to control the selective drawing of power from each of the auxiliary batteries 20 connected to respective auxiliary chargers 18. It will be appreciated that the processor may be separate from the power distribution unit, and may be a part of any part of the system 10.

The system 10 in this example further comprises a power consuming system 26, such as the electrical system in a domestic household, or in a commercial building. The sources of power 13 are connected directly to the power consuming system 26 and are configured to supply power directly to the power consuming system 26 to ensure that there is always sufficient power to power the power consuming system 26, whether from the grid 16 or from the local renewable power sources 14. In some examples, there may be no power consuming system in the system 10.

Therefore, in this example, the grid 16 is connected to the power consuming system 26, the PDU 12 and the local renewable power sources 14 from a grid connection which branches at a junction 24 to each of the power consuming system 26, the PDU 12 and the local renewable power sources 14.

The system 10 in this example further comprises a user interface 28, which is connected to the PDU 12. The user interface 28 may comprise a display to show, for example, which auxiliary batteries 20 are connected to their respective auxiliary chargers 18, the current charge in the auxiliary batteries 20, the priority assigned to each auxiliary battery 20 etc. The user interface 28 may also comprise a user input device, such as a touchscreen interface, in which the user can select priorities, and input any other useful information to the system 10. The user interface 28 may be accessible through a separate and/or remote user input device (e.g. a mobile device such as a mobile phone) or through a dedicated interface.

The system 10 in this example further comprises a metering collar 30 which is configured to be attached to the grid connection upstream of the junction 24 at which the grid connection branches to the PDU 12, the power consuming system 26, and the local renewable power sources 14, to determine whether power is being drawn from the grid 16, or whether excess power, generated from the local renewable power sources 14, is not being consumed by the power consuming system 26, and is therefore being sent to the grid 16.

The metering collar 30 is configured to inductively determine which direction electricity is flowing in the grid connection, to determine whether, and optionally how much, power is being taken from the grid 16 (e.g. to power the power consuming system 26 when no power is being directed to the auxiliary chargers 18, or to power the power consuming system 26 and the auxiliary chargers 18) or whether, and optionally how much, power is being supplied to the grid 16. The metering collar 30 is configured to wirelessly send a signal to the processor 22 relating to the direction of flow of the electricity through the grid connection and the current, relating to the amount of power. In other examples, the signal may be sent by any suitable connection, such as a wired connection, and/or the metering collar may send a signal indicating only the direction of flow of electricity, without an indication of the current or amount of power. In yet further examples, there may be any other suitable device or method employed to determine whether power is being taken from the grid, and/or whether excess power is being supplied to the grid.

Although it has been described that the local renewable power sources 14 are configured to send energy back to the grid 16 when it is not consumed by the power consuming system 26, or directed to the auxiliary chargers 18, in other examples, the local renewable power sources 14 may not be connected to the grid, such that excess power which is not consumed by the power consuming system 26 would simply be lost. In such examples, the metering collar 30 may be replaced with any suitable device for determining that there is excess renewable power generated by the local renewable power sources, which is not being consumed, and is therefore being lost.

It will be appreciated that the system may be reconfigured in any suitable way, with any number of interconnected PDUs, power sources, and power consuming devices.

In this example system 10, each auxiliary battery 20a, 20b, 20c may be assigned a priority by a user, to determine which auxiliary batteries 20 from the plurality of auxiliary batteries 20 should preferentially receive power for charging from the PDU 12. For example, the highest priority for charging could be assigned to the most frequently used car. Optionally, priority can be assigned to determine which auxiliary batteries 20 could preferentially be used to supply power to the PDU 12, such as for use in the power consuming system 26. For example, the highest priority for supplying power could be assigned to the least frequently used car.

In other examples, priority may be predetermined by a user, or dynamically determined, based on the amount of charge currently in each battery, or based on any other suitable criteria. In further examples, power may be distributed and received from the auxiliary batteries 20 randomly, in accordance with the method described herein, rather than by a priority schedule, or altogether equally. In further examples, there may be only a single auxiliary charger connectable to only a single auxiliary battery, such that there may be no need for priority assignment.

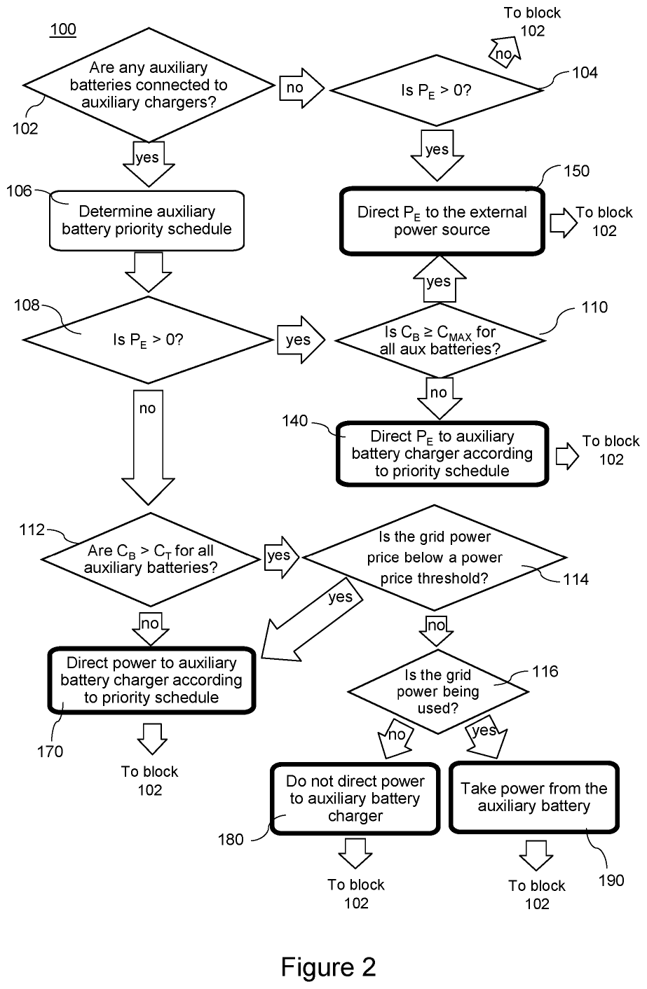

FIG. 2 is a flow chart showing steps of a method 100 for charging the auxiliary batteries 20, which may be performed by the processor 22 in the system 10 described with reference to FIG. 1. It will be appreciated that this method 100 may be carried out on any suitable system.

The method 100 begins at block 102 in which it is determined whether any auxiliary batteries 20 are connected to their respective auxiliary chargers 18, and configured to receive power from the respective auxiliary charger 18 to charge the auxiliary battery 20 and optionally configured to discharge power to the auxiliary charger 18. Block 102 may also comprise identifying which specific auxiliary battery 20 is connected to an auxiliary charger 18. If it is determined that there are no auxiliary batteries 20 connected to respective auxiliary chargers 18, then the method 100 proceeds to block 104.

In block 104, it is determined whether there is excess renewable power, PE generated by the local renewable power sources 14. In the system 10 described in FIG. 1, excess renewable power, PE may come about when there is more power generated by the local renewable power sources 14 than is instantaneously being used by the power consuming system 26. Therefore, the excess renewable power (PE) is defined as power which is not being instantaneously used by the power consuming system, and therefore might be sent to the grid or otherwise lost. In an example in which there is no power consuming system, excess renewable power P_{E} may come about when any renewable power is being generated by the local renewable power sources 14. In this example, excess renewable power P_{E} would therefore flow back into the grid 16 in the absence of flowing elsewhere or be lost. As explained above, with reference to FIG. 1, in this example the availability of excess renewable power P_{E} is determined by the processor 22 from a signal from the metering collar 30. If there is no power being directed to any auxiliary chargers 18, then when the signal from the metering collar 30 indicates that power is being drawn from the grid 16 (i.e. in order to power the power consuming system 26), or that there is no power being drawn from the grid 16 and none is being sent to the grid 16, it is determined that there is no excess renewable power (i.e., P_{E}=0), and when a signal from the metering collar 30 indicates that power is being sent to the grid 16, it is determined that there is excess renewable power (i.e., P_{E}>0).

As explained with reference to FIG. 1, in some examples, the local renewable power sources may not be configured to direct power back into the grid, such that excess renewable power P_{E} would simply be lost, unless it is diverted elsewhere. In such examples, the method may include any suitable way of determining whether there is excess renewable power P_{E} which would be lost.

If it is determined that there is no excess renewable power P_{E} from local renewable power sources 14 (i.e., P_{E}=0), the method 100 loops back to block 102 to start again. If, in block 104, it is determined that there is excess renewable power, P_{E} from local renewable power sources 14 (i.e., P_{E}>0), the method 100 moves to block 150 in which the excess renewable power, P_{E} is directed to the grid 16. From block 150, the method 100 loops back to block 102.

If, in block 102, it is determined that at least one auxiliary battery 20 is connected to the auxiliary charger 18, then the method 100 proceeds to block 106.

It will be appreciated that, in some examples, the method may omit blocks 104 and 150. For example, if there is no connection back to the grid 16 from the local renewable power sources 14, then the method may simply loop back to block 102 from block 102, when it is determined that there are no auxiliary batteries 20 connected to respective auxiliary chargers 18, such that nothing happens or changes until it is determined that at least one auxiliary battery 20 is connected to a respective auxiliary charger 18.

In block 106, a priority schedule is determined for the auxiliary batteries 20 which are connected to the auxiliary chargers 18. The priority schedule determines which auxiliary batteries 20 have priority, and in what order. In some examples, the priority of the auxiliary batteries 20 may be predetermined by a user, for example, by inputting preferences into user interface 28, such as that an electric car battery has a higher priority than a vacuum cleaner battery, or that a first electric car battery for a specific first car has priority over a second electric car battery for a different specific second car. In such examples, the method may identify which auxiliary batteries 20 are connected to an auxiliary charger 18, such as identifying a unique identifier of each connected auxiliary battery 20 to determine which auxiliary battery 20 is entitled to the predetermined priority.

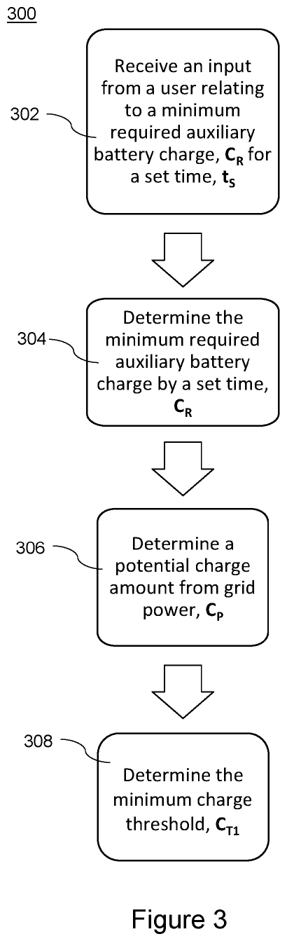

In some examples, the priority schedule may be dynamically determined based on the current charge (CB) of each auxiliary battery 20. For example, the auxiliary battery 20 with the highest priority may be the auxiliary battery 20 which has a lowest absolute charge (e.g., in kWh), or lowest charge proportional to its capacity (e.g., in %). Alternatively, the highest priority may be determined based on the auxiliary battery which has the lowest current charge CB compared to a respective minimum charge threshold (C_{T}), and/or considering a set time (t_{S}) when the auxiliary battery 20 may be required for use. The set time t_{S}, may also be set by a user using the user interface 28, for example. The priority schedule may be based on a combination of predetermined statuses set by the user, and/or a current charge CB of each auxiliary battery 20 and/or a set time t_{S}. The minimum charge threshold C_{T} and the set time t_{S} will be discussed in more detail below with reference to block 112 and FIGS. 3 to 10. In other examples, priority may be equally shared between more than one auxiliary battery 20, such that more than one auxiliary battery 20 is considered simultaneously to have the highest priority.

The method 100 then proceeds to block 108. It will be appreciated that, in examples where there is only one auxiliary battery, or where there is no designated priority, block 106 may be skipped or omitted, and instead block 102 may proceed directly to block 108 in which one or multiple auxiliary batteries 20 are considered.

In block 108, it is determined whether there is excess renewable power P_{E} generated by the local renewable power sources 14, in the same manner as in block 104. If it is determined that there is excess renewable power P_{E} in block 108, then the method proceeds to block 110, in which it is determined whether all of the auxiliary batteries 20 are charged to a maximum charge threshold (C_{MAX}). The maximum charge threshold C_{MAX} for each auxiliary battery 20 may be dynamically determined based on the priority schedule of the connected auxiliary batteries 20, or the maximum charge threshold C_{MAX} may be predetermined for each auxiliary battery 20.

For example, the maximum charge threshold C_{MAX} may be set at 100% (indicating a proportion of charge to capacity) if there is only one auxiliary battery 20 connected to auxiliary chargers 18. In another example, if a set time t_{S} for a first auxiliary battery 20 is very soon (i.e., the set time t_{S} that the auxiliary battery 20 will be required for use, set by the user), and the other auxiliary batteries 20 have set times t_{S} much further away in time, then the maximum charging threshold C_{MAX} for the first auxiliary battery 20 may be set accordingly high to ensure that the first auxiliary battery 20 will continue to be charged while it still can be, before its set time t_{S}.

If it is determined that any one of the connected auxiliary batteries 20 has a current charge C_{B} which has not met or exceeded the maximum charging threshold C_{MAX} (i.e., if C_{B}<C_{MAX}), then the method 100 proceeds to block 140. In block 140, the excess renewable power P_{E} is directed to the auxiliary charger(s) 18 corresponding to the auxiliary battery 20 or auxiliary batteries 20 which have a current charge C_{B} lower than their respective maximum charging threshold C_{MAX}, based on the priority schedule. For example, the highest priority auxiliary battery 20, which has a current charge below its dynamically determined maximum charge threshold C_{MAX}, may be charged until its current charge C_{B} exceeds its dynamically determined maximum charge threshold C_{MAX}, and then the next highest priority auxiliary battery 20 with a current charge C_{B} below its maximum charging threshold C_{MAX} may be charged. It will be appreciated that the determination of which auxiliary battery 20 to charge from the excess renewable power P_{E} may be achieved in any suitable manner, which may be entirely dependent on the application.

In some examples, the excess renewable power P_{E} supplied to the auxiliary chargers 18 may be supplemented by the grid 16, if the excess renewable power P_{E} is not sufficient to power the auxiliary chargers 18 at a required rate. Supplementing the excess renewable power P_{E} with grid power may occur automatically when the PDU 12 draws the required power for the auxiliary chargers 18. In other examples, the PDU may dynamically control the supplementing of excess renewable power P_{E} with power from the grid. From block 140, the method 100 loops back to block 102.

If it is determined, in block 110, that all of the connected auxiliary batteries 20 have a current charge C_{B} which has met or exceeded their respective maximum charging thresholds C_{MAX} (i.e., if C_{B}≥C_{MAX}), then the method 100 proceeds to block 150. In an example where there is no capability to send the power back to the grid 16 or external power source from the local renewable power sources 14, the method may omit block 150 and simply loop back to block 102 from block 110.

It will be appreciated that the priority schedule determined in block 106 and the maximum charging threshold C_{MAX} for each auxiliary battery 20 may be dynamically determined and continually updated.

From block 108, if it is determined that there is no excess renewable power P_{E} generated by the local renewable power sources 14, then the method 100 proceeds to block 112.

In block 112, the method 100 comprises determining whether a minimum charge threshold C_{T} of any of the auxiliary batteries 20 has been exceeded. A detailed example method for determining the minimum charge threshold C_{T} will be discussed in more detail with reference to FIGS. 3-10, below, in examples in which the minimum charge threshold is not simply predetermined or equal to the minimum required charge C_{R}. In this example, each auxiliary battery 20 has a respective minimum charge threshold C_{T}. In other examples, there may be a universal minimum charge threshold Cr which is applied to every auxiliary battery.

In some simplified examples, the minimum charge threshold C_{T} may be predetermined, such as in a look-up table stored locally or from an online source, or may be set based on a predetermined input from a user to the user interface 28. For example, the user may input, to the processor 22 via the user interface 28, a minimum charge threshold C_{T} in the form of a percentage of the capacity for the auxiliary battery 20, or a minimum charging time, which could be a minimum charging time over a specified time period, or from the moment of connecting the auxiliary battery 20. In other examples, the user may input a minimum time of use of the device which the auxiliary battery 20 is configured to power. For example, for a cordless vacuum cleaner or lawnmower, the user may specify a minimum runtime of 20 minutes or a minimum area which must be able to be vacuumed or mowed, and the processor 22 may calculate the required minimum charge threshold C_{T} corresponding to the minimum runtime or the minimum area. In yet further examples, the user interface may be configured to receive any suitable input which corresponds to the minimum required use of the auxiliary battery 20, and from which a minimum charge threshold C_{T} may be calculated. The minimum charge threshold C_{T} may be dynamically calculated based on the input from the user, and the user may input a set time t_{S} by which the minimum charge threshold C_{T} must be reached (such as a set time t_{S} at which the user will need to use the device which the auxiliary battery 20 is configured to power).

If it is determined that the respective minimum charge threshold, C_{T} has not been exceeded for at least one of the auxiliary batteries 20 (i.e., C_{B}≤C_{T} for at least one of the auxiliary batteries 20 which are connected to auxiliary chargers 18), then the method 100 proceeds to block 170, to direct power, from the grid 16, to the auxiliary charger 18 corresponding to the auxiliary battery 20 which has a charge not exceeding the respective minimum charge threshold C_{T}. If multiple auxiliary batteries 20 are connected to respective auxiliary chargers 18 and have current charges C_{B} below their respective minimum charge thresholds C_{T}, in this example, power is directed to the respective auxiliary chargers 18 based on the priority schedule. For example, only the highest priority auxiliary battery 20 may be charged initially until it has a current charge C_{B} exceeding its minimum charge threshold C_{T} (i.e., C_{B}>C_{T}). In other examples, the power may be directed to all of the auxiliary chargers 18 corresponding to auxiliary batteries 20 below their minimum charge threshold simultaneously, with no regard for a priority status. From block 170, the method 100 proceeds to loop back to block 102.

It will be appreciated that there are many other ways to determine which auxiliary battery 20 to charge (from those auxiliary batteries 20 which have current charges C_{B} not exceeding their respective minimum charge thresholds C_{T}) based on priority, respective current charges C_{B} and respective minimum charge thresholds C_{T}.

In block 112, if it has been determined that the minimum charge threshold, C_{T} has been exceeded for all of the connected auxiliary batteries 20, then the method 100 proceeds to block 114.

In block 114, the method 100 comprises determining whether the current grid power price (e.g., the price per kWh of power) is below a power price threshold. For example, the current grid price power may be variable, and may be looked up from an online source, or a predetermined look-up table. The power price threshold may be a predetermined threshold, set by a user, or may be determined by any other suitable means. If the current grid power price is determined to be below the power price threshold, the method 100 proceeds to block 170. This ensures that, even if the minimum charge thresholds C_{T} of the auxiliary batteries 20 have been exceeded, the auxiliary batteries 20 may be further charged when the grid power price is low, thereby reducing costs for the user. Typically, the grid costs are lowest when the electrical demand is lowest, such that this also helps to balance the grid 16 better by not overloading the grid 16 when demand is already high. This may still be limited to charge the auxiliary batteries 20 according to the priority schedule and/or up to the maximum charge threshold C_{MAX}. Of course, the auxiliary batteries cannot be charged beyond 100%, so no further power would be directed to any auxiliary batteries 20 already at 100% charge.

If the grid power price is determined not to be below the power price threshold (i.e. it is determined to be more than or equal to the power price threshold), then the method 100 proceeds to block 116. In block 116, it is determined whether the grid power is being used to power the power consuming system 26. This can be determined with the metering collar 30, when a signal from the metering collar 30 indicates that power is being drawn from the grid 16, it is determined that grid power is being used.

If it is determined that power from the grid power source 16 is not being used to power the power consuming system 26 in block 116, the method 100 proceeds to block 180. In block 180, the method does not direct power to the auxiliary charger 18 (which may simply be passively not directing power to the auxiliary charger 18 or which may involve stopping directing power to the auxiliary charger 18), and then proceeds to loop back to block 102.

If it is determined that power is being drawn from the grid 16 to power the power consuming system 26 in block 116, the method 100 proceeds to block 190. In block 190, power is drawn from the auxiliary battery 20 which has a current charge C_{B} over the minimum charge threshold C_{T} to reduce the grid 16 energy consumption. The method 100 then proceeds to loop back to block 102. If power is being drawn from the grid 16 whilst power is being directed to an auxiliary charger 18, then the method may proceed to block 180 instead of block 190, from block 116. In some examples, if the auxiliary chargers 18 are not configured to receive power from the auxiliary batteries 20, then blocks 116 and 190 may be omitted and the method may proceed directly to block 180 if the grid power price is determined not to be below the power price threshold in block 114.

In some examples, the method may omit blocks 114, 116 and 190, and proceed directly to block 180 if it is determined in block 112 that the minimum charge threshold C_{T} has been exceeded for all connected auxiliary batteries 20.

Including block 114 in the method 100 ensures that, when an auxiliary battery 20 is charged over and above the minimum charge threshold C_{T}, it is done so only from local renewable power sources 14 or with low-cost grid power 16. Further, including blocks 116 and 190 ensures that, if grid power is being used to power something else when the grid power price is high, then the power can be taken from the auxiliary battery 20 which has sufficient charge instead, thereby reducing costs for the user.

The method 100 ensures that the excess renewable power P_{E} generated by a local renewable power source 14 will always preferentially be used to charge the auxiliary battery 20 such as an electric car battery, rather than a dedicated energy storage or simply feeding into the grid, and if there is no excess renewable power P_{E}, that the minimum amount of grid 16 power will be used to charge the auxiliary battery 20 to a minimum level required to be useful to a user. For example, if the auxiliary battery 20 is an electric car battery, and a user has a daily commute of approximately 50 km, the user may set a minimum charge threshold C_{T} corresponding to the amount of charge required for that commute. Then the electric car battery 20 can be reliably charged to a minimum charge threshold Cr using this method 100, regardless of the availability of excess local renewable power, whilst, at the same time, retaining the capacity to store any excess renewable power P_{E} which may be available in the future, without the need for any separate and dedicated energy storage, such as a dedicated battery which has no other primary purpose. This is a more energy efficient solution than sending the excess renewable power, P_{E} to the grid 16, since there are power losses associated with sending power to, and across, the grid 16, and a more resource efficient solution than having a dedicated battery for the purpose of receiving excess renewable power P_{E}. Further, there are cost savings for the user, since the price received for sending excess power to the grid is typically far lower than the cost of taking power from the grid.

In some examples, the method may also include identifying the make and model of the auxiliary battery, to determine its capacity. This may be achieved by any suitable means such as a Bluetooth connection, with a radio frequency identification (RFID), or any other diagnostic tool to determine the capacity of the battery.

It will be appreciated that the method 100 is continually looping, such that all of the determined values and decisions in the flow chart of FIG. 2, may be dynamically changing.

During the method 100, it will be appreciated that, when power is being directed to the auxiliary chargers 18 in block 140, if the metering collar 30 detects that power is being drawn from the grid 16 (rather than being directed to the grid 16), then the method 100 may stop charging the auxiliary battery 20 since this may indicate that there is no longer any excess renewable power, P_{E}. In examples in which the excess renewable power P_{E} is supplemented by power from the grid 16, either automatically or controlled by the PDU, the metering collar 30 detecting that power is being drawn from the grid 16 may not necessarily indicate that there is no longer any excess renewable power P_{E}. However, detecting that more than a threshold amount of power is being drawn from the grid 16 (i.e. more than is required to power the auxiliary charger(s) to which power is being directed, in the absence of excess renewable power P_{E}), would indicate that there is no longer any excess renewable power P_{E}, such that the method 100 may stop directing power to the auxiliary charger(s). Therefore, the threshold amount of power drawn from the grid 16 (used for determining whether there is excess renewable power P_{E}) may be dependent on how many auxiliary chargers 18 the PDU 12 is directing power to at any one time. In other examples, any suitable method or apparatus may be employed to determine if there is excess renewable power, P_{E}.

Although the method 100 described above has been described with reference to multiple auxiliary batteries 20 being considered for charging simultaneously, it will be appreciated that the method 100 may consider only a single connected auxiliary battery 20 with the highest priority at each block, and may loop back to blocks 108 and 112 for different auxiliary batteries 20 with lower priorities.

FIG. 3 is a flow chart showing steps of a first example sub-method 300 for determining a minimum charge threshold C_{T1}.

The first example sub-method 300 begins with block 302 in which an input relating to a minimum required auxiliary battery charge (C_{R}) and a set time t_{S} is received. In a system 10, such as described with reference to FIG. 1, the minimum required charge C_{R} is received by the processor 22, from a user input at the user interface 28, as well as a set time t_{S} by which the minimum required battery charge C_{R} for the auxiliary battery 20 is required. For example, the current time (to) may be 10:00, and the user may input to the processor 22 that they require the auxiliary battery 20 to have a minimum charge of 40% by 13:00 on the same day (i.e., C_{R}=40%, t_{S}=13:00).

In other examples, the user may input a minimum required charge C_{R} in the form of a minimum charging time (i.e., a minimum amount of time that an auxiliary battery must be charged for) by the set time t_{S}. In other examples, the user may input a minimum required amount of use time of the device which the auxiliary battery 20 is configured to power. For example, for an auxiliary battery 20 configured to power a cordless vacuum cleaner or lawnmower, the user may specify a minimum runtime of 20 minutes or a minimum area which must be able to be vacuumed or mowed, and the processor 22 may calculate the minimum required auxiliary battery charge C_{R} corresponding to the input minimum runtime or minimum area. In yet further examples, the user may specify a travel distance that an electric car must be able to travel by a set time t_{S}, and the processor 22 may be able to determine the minimum required auxiliary battery charge C_{R} from the travel distance. In other examples, the user may supply, and/or processor 22 may receive, any suitable input which corresponds to the minimum required use of the auxiliary battery 20, and from which a minimum required auxiliary battery charge C_{R} may be determined.

The first sub-method 300 then proceeds to block 304 in which the minimum required auxiliary battery charge C_{R} is determined. In some examples, if the input from the user is the minimum required auxiliary battery charge C_{R}, then block 304 may not be required. In some examples, the input may require conversion or calculations to determine the actual minimum required auxiliary battery charge C_{R}. In other examples, a factor of safety may be applied to any input received to determine the minimum required auxiliary battery charge C_{R}. For example, for a cordless vacuum cleaner battery, if the user specifies a minimum runtime or minimum area coverage of 100 m², this may require a battery charge of approximately 50% to complete. However, the processor 22 may apply a factor of safety of 1.2, for example, to arrive at a minimum required auxiliary battery charge, C_{R} of 60%. The factor of safety may be dynamically determined based on current and/or predicted temperatures of the auxiliary batteries 20 since power available from batteries is temperature dependent. From block 304, the first example sub-method 300 proceeds to block 306.

In block 306, a potential charge amount C_{P} from the grid 16 is determined. The potential charge amount C_{P} is the amount of charge which could be added from a current time to the set time t_{S}, if continuous power from the grid power source 16 is directed to the respective auxiliary charger 18. For example, if the current time t₀ is 10:00, and the set time t_{S} is 13:00, then there are 3 hours of charging time available from the grid power source 16. The processor 22 may calculate that, over 3 hours, the auxiliary battery may charge by an additional 75%. Therefore, the potential charge amount C_{P} is 75%.

The first example sub-method 300 then proceeds to block 308, in which the minimum charge threshold C_{T1} is calculated. The minimum charge threshold, C_{T1} is calculated by subtracting the potential charge amount C_{P} from the minimum required auxiliary battery charge C_{R} (i.e., C_{T1}=C_{R}−C_{P}). In the example above, the minimum charge threshold C_{T1} would therefore be found to be 40%−75%=−35%.

Therefore, when the first example sub-method 300 is applied to the method 100, the auxiliary battery 20 would only be charged from the grid power source 16 from the latest available time to do so. Before this moment, only excess renewable power P_{E} from the local renewable power sources 14 would be used to charge the auxiliary battery 20. The first example sub-method 300 may loop to continually (i.e., dynamically) adjust the determined minimum charge threshold C_{T1}.

This first example sub-method 300 would result in the auxiliary battery 20 often being charged only up to the minimum required auxiliary battery charge C_{R} by the set time t_{S}. This ensures that the auxiliary battery 20 is never using more power from the grid 16 (for example, or any external power source 16) than is absolutely necessary at any one time. When power is not taken from the grid 16, this is particularly advantageous in not unnecessarily loading the grid 16, which must be continually carefully balanced. This first example sub-method 300 may selectively be used, such as during daytime hours, to reduce the load on the grid 16, or when grid power prices are typically high. This also leaves more room for the auxiliary battery 20 to be charged by excess renewable power P_{E} that becomes available, above and beyond the minimum charge threshold C_{T}.

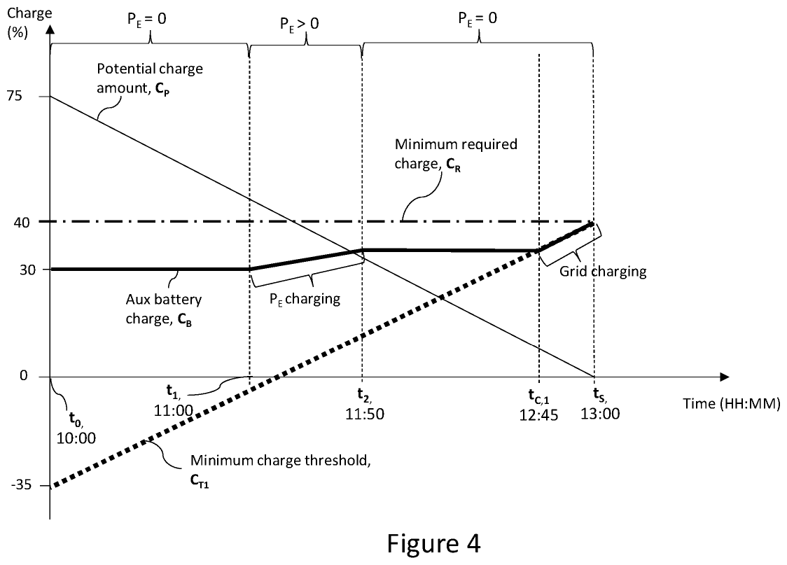

FIG. 4 is a graph showing the charge amounts in a first example sub-method 300 when applied to the method 100 described with reference to FIG. 2, having a single auxiliary battery 20 connected to an auxiliary charger 18 for charging. In this example, it is assumed that there is no demand from the auxiliary battery to the power consuming system 26 in accordance with block 190, and that the grid power price is not below the power price threshold.

The graph shows time along the x-axis and charge in % (of capacity) on the y-axis. In the example given above, where the current time t₀ is 10:00, and the user inputs a set time t_{S} of 13:00 with a minimum required auxiliary battery charge C_{R} of 40%. The minimum required auxiliary battery charge C_{R} is shown as a horizontal line at 40% (i.e., a constant in time).

The potential charge amount C_{P} is calculated to be 75% at t₀ (10:00) and, by definition, the potential charge amount C_{P} must be 0% at t_{S} (13:00), since the potential charge amount C_{P} is the amount of charge which can be added between the instantaneous current time and the set time t_{S} with continual power from the grid 16. Therefore, the potential charge amount C_{P} is a straight line passing through (t₀, 75) and (t_{S}, 0). In other examples, the relationship may not be linear such that the line passing through those points may not be straight, and may depend on the charging characteristics of the auxiliary battery which may be predetermined or learned with historical data over time.

The minimum charge threshold C_{T1} is calculated with C_{T1}=C_{R}−C_{P}, and therefore forms an inverted line to the potential charge amount C_{P} line, with the minimum charge threshold C_{T1} line passing through points (t₀, −35) and (t_{S}, 40) (i.e., the potential charge amount C_{P} line and the minimum charge threshold line C_{T1} having the same absolute gradient but with and inverse relationship, with negative and positive signs respectively, and different y-intercepts).

If an auxiliary battery 20 is connected to an auxiliary charger 18 at time t₀=10:00, and has a battery charge of 30%, then an auxiliary battery charge C_{B} line begins at point (t₀, 30). Since there is only one auxiliary battery 20 connected, in this example, the maximum charge threshold C_{MAX} would be 100%, such that, if there is any excess renewable power, P_{E} it will be used to charge the auxiliary battery 20 (in accordance with blocks 108, 110 and 140) until it is fully charged.

In this example, it is assumed that between t₀ and t_{S}, there is only excess renewable power P_{E} available between t₁ (11:00) and t₂ (11:50) which are both marked on the graph, and that the rest of the time there is no excess renewable power P_{E}.

At time t₀, there is no excess renewable power P_{E} (from block 108 in FIG. 2 which then proceeds to block 112), and it can be seen that the auxiliary battery charge C_{B} is 30% and that the minimum charge threshold C_{T1} is −35%, such that C_{B}>C_{T1}. Therefore, following blocks 112, 114, 116 and 180, no power is provided to the auxiliary charger 18 to charge the auxiliary battery 20. This remains the case until time t₁, at which point there is excess renewable power, P_{E} available.

At t₁, following blocks 108, 110 and 140, the excess renewable power, P_{E} is directed to the auxiliary battery charger 18 to charge the auxiliary battery 20, such that it can be seen that the auxiliary battery charge C_{B} increases from t₁ until t₂. At t₂, the auxiliary battery charge C_{B} plateaus since there is no longer any excess renewable power P_{E}, and the auxiliary battery charge C_{B} is still above the minimum charge threshold C_{T1}.

At a critical time t_{C,1}, which in this example is 12:45 the minimum charge threshold C_{T1}, meets the auxiliary battery charge C_{B} such that the method 100 follows blocks 112 and 170 to direct grid power 16 to the auxiliary battery 20 to charge the auxiliary battery 20 up to the minimum required charge C_{R}, of 40% by the set time t_{S} at 13:00.

Note that the method 100 will automatically compute a critical time, t_{C,1} which is the point at which, even without excess renewable power available, there is still enough time left to reach the minimum require auxiliary battery charge C_{R} by switching to grid power. This point is at the intersection of the minimum charge threshold C_{T} line with the auxiliary battery charge C_{B} line.

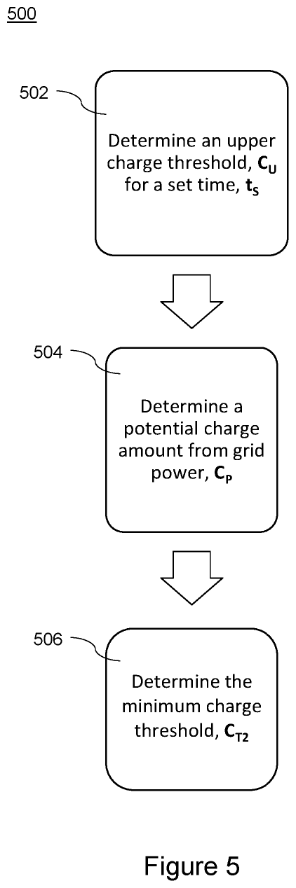

FIG. 5 is a flow chart showing a second example sub-method 500 for determining a minimum charge threshold C_{T2}.

The second example sub-method 500 begins at block 502, in which an upper charge threshold C_{U} is determined for a set time t_{S}. The upper charge threshold C_{U} may be the same as the maximum charge threshold C_{MAX} or may be a different threshold. The upper charge threshold may represent a desired auxiliary battery charge C_{B} by the set time t_{S}. For example, a user may like to have their auxiliary battery 20 charged to at least 85% for peace of mind, and so may set their upper charge threshold at C_{U}=85%.

The second example sub-method 500 then proceeds to block 504 in which a potential charge amount C_{P} is determined, in the same manner as in block 306 described with reference to FIG. 3. Using the same example as described with reference to FIGS. 3 and 4, the current time t₀ may be 10:00 and the set time t_{S} may be 13:00, such that the potential charge amount C_{P} from t₀ to t_{S} may be calculated to be 75%.

The second example sub-method 500 then proceeds to block 506 in which the minimum charge threshold C_{T2} is determined. In this example, the minimum charge threshold C_{T2} is determined by subtracting the potential charge amount C_{P} from the upper charge threshold C_{U} (i.e., C_{T2}=C_{U}−C_{P}).

This second example sub-method 500 would result in the auxiliary battery 20 often being charged up to the upper charge threshold C_{U} by the set time t_{S}. This increases the likelihood that the auxiliary battery 20 will still have enough capacity to charge with any excess renewable power P_{E} which is available while it is connected to the auxiliary charger 18, whilst ensuring that the auxiliary battery 20 is charged up to the upper charge threshold C_{U} by the time it is needed for use by the user (i.e., by the set time t_{S}).

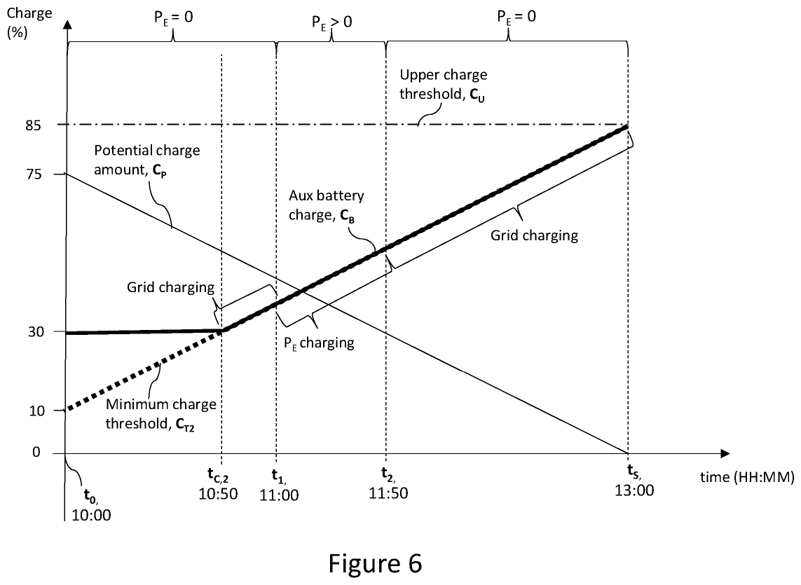

FIG. 6 is a graph showing the charge amounts of an auxiliary battery 20 in the second example sub-method 500 with the method 100 described with reference to FIG. 2.

The graph shows time along the x-axis and charge in % of capacity on the y-axis, in the example given above with reference to FIG. 5, where the current time t₀ is 10:00, and the user inputs a set time t_{S} of 13:00 with an upper charge threshold C_{U} of 85%. The upper charge threshold, C_{U} is shown as a horizontal line at 85% (i.e., a constant in time). As in the example shown in FIG. 4, the potential charge amount, C_{P} is calculated to be 75% at t₀ (10:00), and by definition, the potential charge amount, C_{P} must be 0% at t_{S} (13:00). Therefore, the potential charge amount, C_{P} is a straight line passing through (t₀, 75) and (t_{S}, 0). In other examples, the relationship may not be linear such that the line passing through those points may not be straight.

As explained above with reference to FIG. 5, the minimum charge threshold C_{T2} is calculated with C_{T2}=C_{U}−C_{P}, and therefore forms an inverted line to the potential charge amount C_{P} line, with the minimum charge threshold C_{T2} line passing through points (t₀, 10) and (t_{S}, 85) (i.e., the potential charge amount C_{P} line and the minimum charge threshold line Cr having the same absolute gradient but with an inverse relationship having negative and positive signs respectively, as passing through different y-intercepts).

If an auxiliary battery 20 is connected at time t₀=10:00, and has a current charge of 30%, then an auxiliary battery charge C_{B} line begins at point (t₀, 30). In this example, there may be more than one auxiliary battery 20 connected, such that the maximum charge threshold C_{MAX} may be equal to the upper charge threshold C_{U} at 85%, such that, if there is any excess renewable power, P_{E} it will be used to charge the auxiliary battery 20 (in accordance with blocks 108, 110 and 140) up to 85%, after which, the charging may switch to another, lower priority, connected auxiliary battery 20. It will be appreciated that the maximum charge threshold C_{MAX} may be adapted dependent on a number of factors, as explained with reference to FIG. 2.

In this example, as with the example described with reference to FIG. 4, it is assumed that between t₀ and t_{S}, there is only excess renewable power, P_{E} available between t₁ (11:00) and t₂ (11:50) which are both marked on the graph, and that the rest of the time there is no excess renewable power P_{E}. Further, it is assumed that the grid power price is above the power price threshold between 10:00 and 13:00, and for simplicity, it is assumed that there is no demand from the auxiliary battery 20 at any time t₀ the power consuming system 26 in accordance with block 190.

At time t₀, there is no excess renewable power P_{E} (from block 108 in FIG. 2 which then proceeds to block 112), and it can be seen that the auxiliary battery charge C_{B} is 30% and that the minimum charge threshold C_{T2} is 10%, such that C_{B}>C_{T2}. Therefore, following blocks 112, 114, 116 and 180, no power is provided to the auxiliary charger 18 to charge the auxiliary battery 20. This remains the case until the critical time t_{C,2} (10:50) at which point the minimum charge threshold C_{T2} meets the auxiliary battery charge C_{B}, such that the method 100 follows blocks 112 and 170 to direct power to the auxiliary battery 20 to charge the auxiliary battery 20 up to time t₁.

Between t₁ and t₂, the method 100 follows blocks 108, 110 and 140, such that the excess renewable power, P_{E} is directed to the auxiliary battery charger 18 to charge the auxiliary battery 20 up to time t₂. It will be appreciated that, in some instances, there may be excess renewable power P_{E} generated, but that this power may not have a sufficient voltage to charge the auxiliary battery 20 at its normal charging rate. In such instances (in any of the methods described herein), the processor 22 may either simply determine that there is no excess renewable power, or charge with the excess renewable power P_{E}, below the normal charging rate (for example, when the auxiliary battery charge C_{B} is above its minimum charge threshold C_{T}, or when an upper charge threshold C_{U} is used to determine the minimum charge threshold C_{T}, as it may not be critical that the auxiliary battery charge C_{B} actually reaches the upper charge threshold C_{U}), or the processor 22 may alternatively determine that the excess renewable power should be supplemented with power from the grid 16, for example, by considering whether the auxiliary battery charge C_{B} is below the minimum charge threshold C_{T}, and if it is, supplementing the excess renewable power P with power from the grid 16 so that the auxiliary battery 20 is charged at its normal charging rate. At time t₂, there is no longer any excess renewable power P_{E}, but since the auxiliary battery charge C_{B} is still just below or equal to the minimum charge threshold C_{T2} as it increases, the method 100 continues to follow blocks 112 and 170 to direct power to the auxiliary battery 20 to charge the auxiliary battery 20 up to 85% by set time t_{S}.

It can therefore be seen from FIGS. 3-6 that these differences in determining the minimum charge threshold C_{T1} or C_{T2} result in different charging outcomes for the auxiliary battery 20 under similar conditions. Both the first and second sub-methods 300, 500 make best use of the renewable power available, and minimise use of the grid power 16, whilst ensuring that user requirements are met.

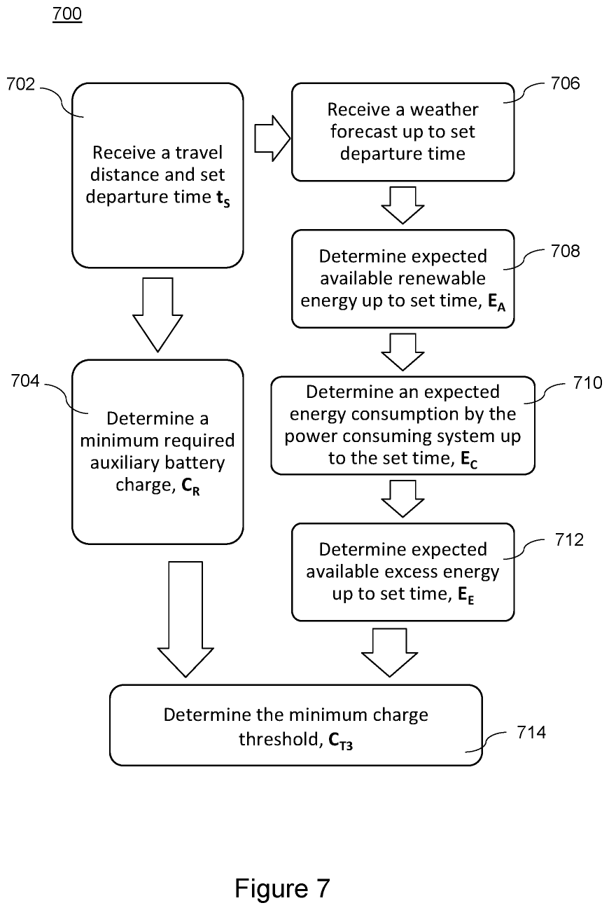

FIG. 7 is a flow chart showing a third example sub-method 700 for determining a minimum charge threshold C_{T3}, specifically for an auxiliary battery 20 in the form of an electric car battery 20. In an example system, such as the system 10 described with reference to FIG. 1, the third example sub-method 700 may be carried out by the processor 22.

The third example sub-method 700 begins at block 702. Block 702 comprises receiving a travel distance and a set departure time t_{S}. In this example, a user inputs a travel destination to the processor 22, and a required set time, t_{S}, and the processor 22 calculates the travel distance from the current location. In other examples, the user may input the required arrival time, and the processor may determine the required departure time t_{S}, or the user may input the travel distance directly to the processor 22. For example, the user may input a destination which is 30 km away from the current location and may set a departure time t_{S} of 8:00 am.

From block 702, the third example sub-method 700 divides into two branches which may occur simultaneously or consecutively in any suitable order. The first branch comprises block 704 in which a minimum required auxiliary battery charge C_{R} is determined, based on the travel distance input by the user. In a simplified example, the minimum required auxiliary battery charge C_{R} may be based simply on the travel distance, and the expected charge required for achieving this travel distance. A factor of safety may be used to account for variations, and give a conservative minimum required auxiliary battery charge C_{R}. In an example in which the travel distance is 30 km, it may require a corresponding charge of 15%, and a factor of safety of 1.5 may be applied to arrive at a minimum required auxiliary battery charge of 22.5%.

In a more complex example, the minimum required auxiliary battery charge C_{R} may be calculated based on the expected fastest route from the set time t_{S} and optionally taking expected traffic conditions into account. For example, the determined minimum required auxiliary battery charge C_{R} may consider the travel time and speed, accounting for more accelerations and decelerations in heavy traffic conditions and any other variables which may affect the total charge used in the car battery for an expected journey. Historical data for traffic conditions may be used, for example covering a percentile of worst traffic conditions at a particular time, such as a 95^{th} percentile or 99^{th} percentile, to calculate the minimum required auxiliary battery charge C_{R}, or historical data may be used for similar journeys that the electric car has made, and the amount of charge which was used in those journeys. For example, in the example of a 30 km journey, with heavy traffic expected on approximately 10% of the recommended route at 8:00 (the set departure time t_{S}), the required auxiliary battery charge C_{R} to achieve this journey may be 20%. This could be used as the minimum required auxiliary battery charge C_{R} or a factor of safety could be applied, such as 1.5, to arrive at a minimum required auxiliary battery charge of 30%.

It may be possible for the minimum required auxiliary battery charge C_{R} to take multiple journeys into account, in the event that it is not possible, or unlikely, to charge the car battery between journeys, for example a return journey for a work commuter.

The minimum required charge amount C_{R} from block 704 is taken to block 714, which also uses an output from the second branch.

The second branch begins at block 706 and proceeds up to block 712. In block 706, the third example sub-method 700 comprises receiving a weather forecast up to the set departure time t_{S}. In other examples, block 706 may comprise receiving historical data of weather patterns to estimate a weather forecast up to the set time t_{S}. The third example sub-method 700 then moves to block 708.

In block 708, the third example sub-method 700 comprises determining expected available renewable energy (EA) up to the set time t_{S}. The expected available renewable energy EA relates to the amount of energy expected to be generated by the local renewable power sources 14 up to the set time t_{S}. The weather forecast may be used to determine this. For example, the time of the year and the time of the day, the area of any local solar panel system and its orientation, and the orientation of a local wind turbine, together with the weather forecast may be used to determine the expected available power from local renewable power sources 14. A similar calculation can be conducted for any other local renewable power sources 14 which feed into the system 10. For example, the current time, to may be 10:00 in mid-July, and the set departure time t_{S} may be 13:00 in a domestic home having 6 solar panels and a small wind turbine. Between the current time and the set departure time, t_{S} there may be a cloudless sky forecast with no or low wind, such that there may be an expected available energy from the local renewable power sources 14 of approximately 7 kWh (in this example, primarily from a solar panels). The third example sub-method 700 then proceeds to block 710.

In some examples, block 708 may comprise receiving historical data of available local renewable energy, taking into account times of the day, months of the year, as well as weather patterns for example, and any other data, such that the expected available local renewable power EA can be determined from the historical data.

Block 710 comprises determining an expected energy consumption (E_{C}) from the power consuming system 26 up to the set time t_{S}, for example a domestic household. This may be done using historical data from the power consuming system 26, taking into consideration the time of year, the days of the week and the time of day etc. In other examples, the expected energy consumption E_{C} may be estimated based on the number of occupants, the size of the building, purpose of the building e.g. domestic household, office space, or factory, and any other factors which may influence the power consumption of the local power consuming system 26. The third example sub-method 700 then proceeds to block 712.

In block 712, the third example sub-method 700 comprises determining the expected available excess renewable energy (EE) up to the set time t_{S}, by subtracting the expected energy consumption E_{C} up to the set time t_{S} from the expected available energy EA up to the set time t_{S} (i.e., E_{E}=E_{A}−E_{C}). The third example sub-method 700 then proceeds to block 714. It will be appreciated that blocks 708 and 710 may be conducted in the order shown, simultaneously or in the opposite order to that shown in FIG. 7.

Block 714 comprises determining the minimum charge threshold C_{T3} using the expected available excess energy E_{E} and the minimum required auxiliary battery charge C_{R}. In this example, the minimum charge threshold C_{T3} is calculated by subtracting the expected available excess energy E_{E} from the minimum required auxiliary battery charge, C_{R} (when these two variables are in a common form, such as a percentage of the auxiliary battery capacity, or kWh) (i.e., C_{T3}=C_{R}−E_{E}). This ensures that the grid power 16 is used to charge the electric car battery 20 only up to a point necessary to achieve the minimum required auxiliary battery charge C_{R}, while all of the expected available excess energy is also used to charge up the auxiliary battery 20 up to the set time t_{S}.

Although the third example sub-method 700 has been described with reference to an electric car battery specifically, it will be appreciated that it could be applied to any auxiliary battery 20 by changing block 702 to receive a user input relating to the minimum required auxiliary battery charge C_{R}, similar to block 302 in FIG. 3.

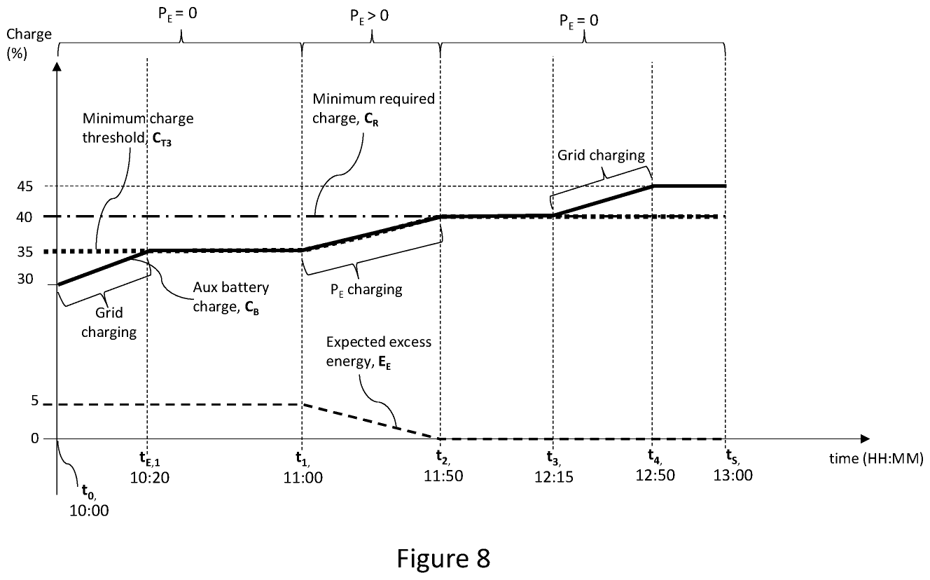

FIG. 8 is a graph showing the charge amounts of an auxiliary battery 20 in the third example sub-method 700 when applied to an electric car battery 20 with the method 100, described with reference to FIG. 2.

The graph shows time along the x-axis and charge in % of capacity on the y-axis. In the example given above, where the current time t₀ is 10:00, and the user inputs a set time t_{S} of 13:00 with a minimum required charge C_{R} of 40% (i.e., the same as the graph shown in FIG. 4). The minimum required charge C_{R} is therefore shown as a horizontal line at 40% (i.e., a constant in time).

Blocks 706-712 in this example calculate the expected available excess renewable energy E_{E} to equate to a charge of 5% of the battery up to the set time, t_{S}. This is expected to be achieved between t₁ and t₂, which is when there is expected to be available excess renewable energy E_{E}. Therefore, a line showing expected available excess energy E_{E} begins at (t₀, 5), and stays constant until t₁, where it begins to diminish linearly until t₂, where it is at 0%, and stays at 0% until the set time t_{S}. In other examples, the reduction may not be linear. The expected available excess E_{E} may change dynamically over time, as the weather forecast changes to reflect more accurate forecasting.

The minimum charge threshold C_{T3} which is calculated with C_{T3}=C_{R}−E_{E}, therefore begins at (40−5)=35% at t₀. It stays constant until t₁, where is begins to increase linearly to account for the linear change in the expected available excess renewable energy E_{E}, until t₂, where it is at 40%, and stays at 40% in line with the minimum required auxiliary battery charge C_{R} until the set time t_{S}.

If an auxiliary battery 20 is connected at time t₀=10:00, and has a current charge of 30%, then an auxiliary battery charge C_{B} line begins at point (t₀, 30). In this example, there is only one auxiliary battery 20 connected, such that the maximum charge threshold C_{MAX} would be 100%, such that, if there is any excess renewable power, P_{E} available, it will be used to charge the auxiliary battery 20 (in accordance with blocks 108, 110 and 140).

In this example, it is assumed that between t₀ and t_{S}, there is excess renewable power, P_{E} available between t₁ (11:00) and t₂ (11:50) of up to 5% charge. Times t₁ and t₂ are marked on the graph, and the rest of the time there is no excess renewable power, P_{E} available. Further, it is assumed that the grid power price is below the power price threshold between times t₃ (12:15) and t₄ (12:50) which are also marked on the graph, and it is assumed that there is no demand from the auxiliary battery to the power consuming system 26 in accordance with block 190.

At time t₀, there is no excess renewable power P_{E} (from block 108 in FIG. 2 which then proceeds to block 112), and it can be seen that the auxiliary battery charge C_{B} is 30% and that the minimum charge threshold C_{T3} is 35%, such that C_{B}≤C_{T3}. Therefore, following blocks 112 and 170, the method 100 proceeds to direct power to the auxiliary charger 18 to charge the auxiliary battery 20, up to an equalising time, t_{E,1} (10:20).

At t_{E,1}, the auxiliary battery charge C_{B} meets and exceeds the minimum charge threshold C_{T3}, such that the method 100 follows blocks 112, 114, 116 and 180, while the grid power price is above the power price threshold, to not direct power to the auxiliary charger 18. The auxiliary battery charge C_{B} therefore plateaus at just over 35% until t₁.

At t₁, following blocks 108, 110 and 140, the excess renewable power P_{E} is directed to the auxiliary charger 18 to charge the auxiliary battery 20, such that it can be seen that the auxiliary battery charge C_{B} increases from t₁ until t₂. At t₂, the auxiliary battery charge C_{B} plateaus since there is no longer any excess renewable power, P_{E}, and the auxiliary battery charge C_{B} is still above the minimum charge threshold C_{T3}.

At time, t₃, which in this example is 12:15, the grid power price falls below the power price threshold such that the method follows blocks 112, 114, and 170 to direct power to the auxiliary charger 18 up to time t₄, at which point the auxiliary battery charge C_{B} has risen to 45%. At t₄, the grid power price rises above the power price threshold, such that the method 100 follows blocks 114, 116 and 180 again to not/stop directing power to the auxiliary charger 18, and such that the auxiliary battery charge C_{B} plateaus at 45% until the set time t_{S}.

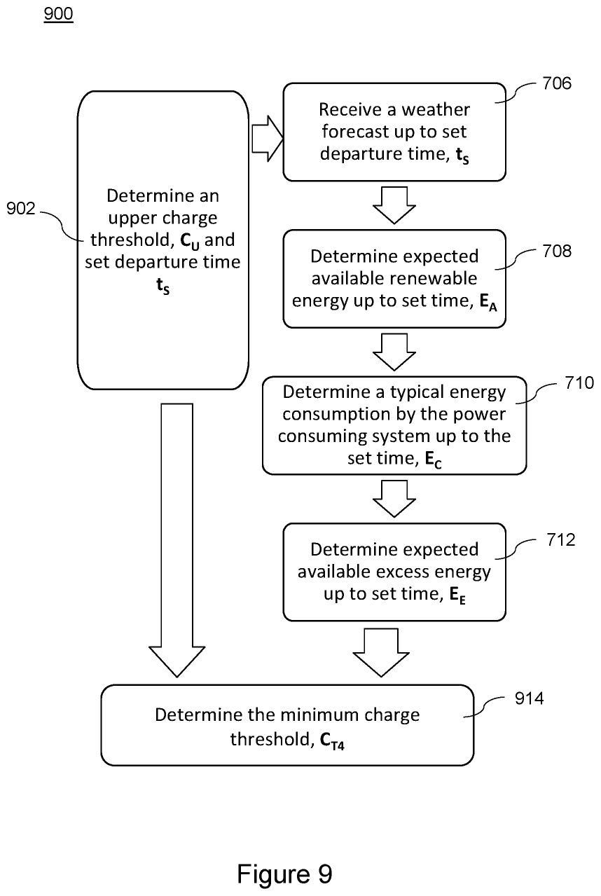

FIG. 9 is a flow chart showing a fourth example sub-method 900 for determining a minimum charge threshold C_{T4}, which is similar to the third example sub-method 700 described with reference to FIG. 7. In an example system, such as the system 10 described with reference to FIG. 1, the fourth example sub-method 900 may be carried out by the processor 22.

The fourth example sub-method 900 begins at block 902 in which an upper charge threshold C_{U} is determined for a set time t_{S}. The upper charge threshold C_{U} may be determined in a similar manner as in block 502 as described in FIG. 5. From block 902, the method proceeds to block 914 in a first branch, and to block 706 in a second branch. The fourth example sub-method 900 is similar to the third example sub-method in having a second branch of blocks 706-712. Blocks 706-712 are similar in the fourth example sub-method 900 to the third example sub-method 700, and differ only in that the fourth example method 900 proceeds to block 914 from block 712, having determined an expected available excess renewable energy E_{E} up to the set time t_{S}.

Block 914 comprises determining the minimum charge threshold C_{T4} using the expected available excess energy E_{E} and the upper charge threshold C_{U}. In this example, the minimum charge threshold C_{T4} is calculated by subtracting the expected available excess energy E_{E} from the upper charge threshold C_{U} (when these two variables are in a common form, such as a percentage of the auxiliary battery capacity, or kWh) (i.e., C_{T4}=C_{U}−E_{E}). This ensures that, at most, grid power 16 is used to charge the auxiliary battery 20 up to the upper charge threshold C_{U}, while ensuring that there is enough battery capacity to receive all of the expected available excess energy E_{E} is up to the set time, t_{S}.

The minimum required auxiliary battery charge C_{R} in FIG. 7 and the upper charge threshold C_{U} in FIG. 9 may also be dynamically determined by applying a factor of safety based on how much time there is between the current time and the set time t_{S} and the expected accuracy of the weather forecast, expected available renewable energy E_{A}, and expected energy consumption E_{C}, to take into account inaccurate predictions, which may become more accurate over time. Such a factor of safety may account for larger errors in predicted values, where the time between now and the set time t_{S} is larger. For example, the minimum required charge C_{R} or the upper charge threshold C_{U} could be determined by applying a factor of safety larger than 1, to ensure that there is at least the required battery charge for the required use, or the upper charge threshold could be determined by applying a factor of safety smaller than 1, to minimise the risk that the auxiliary battery 20 will not have capacity to store unexpected excess renewable energy from the local renewable power source 14. This increases the likelihood that the excess local renewable energy up to the set time t_{S} will not need to be fed back to the grid 16, or go to waste, whilst still almost fully charging the auxiliary battery 20.

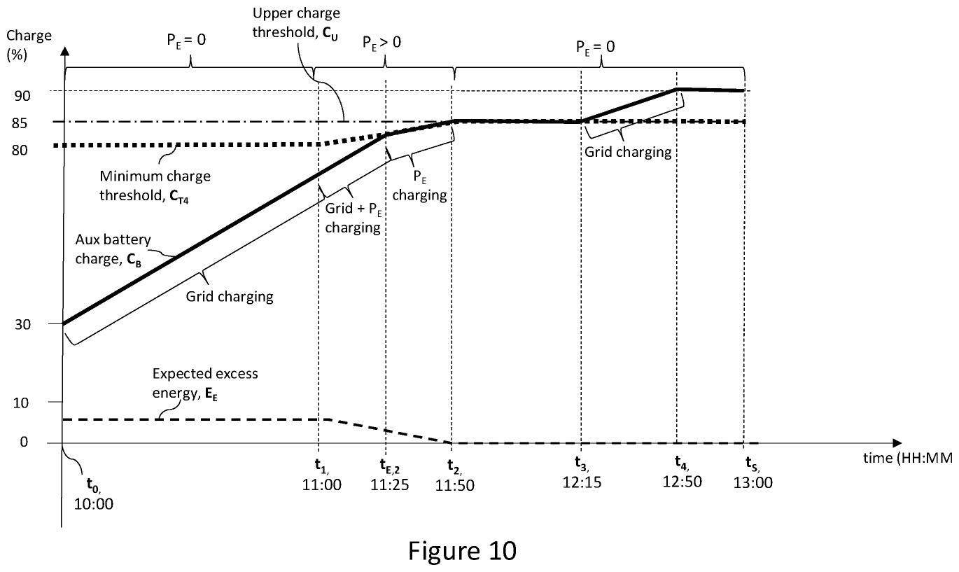

FIG. 10 is a graph showing the charge amounts of an auxiliary battery 20 in the fourth example sub-method 900 with the method 100, described with reference to FIG. 2.

The graph shows time along the x-axis and charge in % of capacity on the y-axis. In the example given above, where the current time t₀ is 10:00, and the user inputs a set time t_{S} of 13:00 with an upper charge threshold C_{U} of 85% (i.e., the same as the graph shown in FIG. 6), the upper charge threshold C_{U} is therefore shown as a horizontal line at 85% (i.e., a constant in time).

Blocks 706-712 in this example calculate the expected available excess renewable energy E_{E} equating to a charge of 5% of the battery up to the set time t_{S}. This is expected to be achieved between t₁ and t₂, which is when there is expected to be available excess renewable energy. Therefore, a line showing expected available excess energy, E_{E} begins at (t₀, 5), and stays constant until t₁, where is begins to diminish linearly until t₂, where it is at 0%, and stays at 0% until the set time, t_{S}. In other examples, the reduction may not be linear.

The minimum charge threshold, C_{T4} is calculated with C_{T4}=C_{U}−E_{E}, therefore begins at (85−5)=80% at t₀. It stays constant until t₁, where is begins to increase linearly to account for the linear change in the expected available excess renewable energy E_{E}, until t₂, where it is at 85%, and stays at 85% in line with the upper charge threshold C_{U} until the set time, t_{S}.

If an auxiliary battery 20 is connected at time t₀=10:00, and has a current charge of 30%, then an auxiliary battery charge C_{B} line begins at point (t₀, 30). In this example, there is only one auxiliary battery 20 connected, such that the maximum charge threshold C_{MAX} would be 100%, such that, if there is any excess renewable power P_{E} available, it will be used to charge the auxiliary battery 20 until it is fully charged (in accordance with blocks 108, 110 and 140).

In this example, it is assumed that between t₀ and t_{S}, there is excess renewable power, P_{E} available between t₁ (11:00) and t₂ (11:50) of up to 5% charge. Times t₁ and t₂ are marked on the graph, and the rest of the time there is no excess renewable power, P_{E} available. Further, it is assumed that the grid power price is below the power price threshold between times t₃ (12:15) and t₄ (12:50) which are also marked on the graph. It is assumed that between t₀ and t_{S} there is no demand from the auxiliary battery to the power consuming system 26 in accordance with block 190.

At time t₀, there is no excess renewable power P_{E} (from block 108 in FIG. 2 which then proceeds to block 112), and it can be seen that the auxiliary battery charge C_{B} is 30% and that the minimum charge threshold C_{T4} is 80%, such that C_{B}≤C_{T4}. Therefore, following blocks 112 and 170, the method 100 proceeds to direct power from the grid 16 to the auxiliary charger 18 to charge the auxiliary battery 20 up to an equalising time, t_{E,2} (11:25). Between t₁ and t_{E,2}, there is excess renewable power P_{E}, such that the method 100 follows blocks 108, 110 and 140, to direct power to the auxiliary charger 18, however, the gradient of the increase in auxiliary battery charge C_{B}, is higher than the absolute gradient of the expected excess energy E_{E}, indicating that the excess renewable power P_{E} available does not have a high enough voltage to charge the auxiliary battery 20 at the same rate as the grid 16 would. Since the auxiliary battery charge C_{B} is below the minimum charge threshold C_{T4} between t₁ and t_{E,2}, the processor 22 in this example controls the PDU 12 to supplement the power supplied with power from the grid 16. In other examples, if the excess renewable power voltage is too low, the processor may determine that there is no excess renewable power, or may simply permit charging at the rate supplied by the excess renewable power P_{E} without supplementing it from the grid 16. At time t_{E,2}, the auxiliary battery charge C_{B} exceeds the minimum charge threshold C_{T4}, such that the method 100 continues along blocks 108, 110 and 140 up to time t₂, but does not supplement the excess renewable power P_{E} available, such that the auxiliary battery charge C_{B} follows the minimum charge threshold C_{T4} line up to time t at which it is at just over 85%.

At time t₂, the auxiliary battery charge C_{B} exceeds the minimum charge threshold C_{T4}, such that the method 100 follows blocks 112, 114, 116 and 180, while the grid power price is above the power price threshold, to not direct (stop directing) power to the auxiliary charger 18. The auxiliary battery charge C_{B} therefore plateaus at just over 85% until t₃.

At time, t₃, which in this example is 12:15, the grid power price falls below the power price threshold such that the method follows blocks 112, 114 and 170 to direct power to the auxiliary charger 18 up to time t₄, at which point the auxiliary battery charge, C_{B} has risen to 90%. At t₄, the grid power price rises above the power price threshold, such that the method 100 follows blocks 114, 116 and 180 again to not direct power to the auxiliary charger 18, and so the auxiliary battery charge C_{B} plateaus at 90% until the set time, t_{S}.

Although it has been described, with reference to FIGS. 7 and 9, that blocks 706-712 receive a weather forecast, determine expected available energy E_{A} up to a set time, determine expected energy consumption E_{C} up to a set time, and thereby determine expected available excess energy E_{E}, in some examples, blocks 706-712 together may instead receive historical data of available excess power E_{A}, and determine expected available excess energy E_{E} up to the set time, t_{S} based on the historical data, for example using machine learning.

It will be appreciated that the second branch from block 706 to block 712 in FIGS. 7 and 9 may be omitted from the third and fourth example sub-methods 700 and 900, such that the minimum charge threshold C_{T3}, C_{T4} is simply determined from the minimum required auxiliary battery charge C_{R} in block 704 and the upper charge threshold C_{U} in block 902 respectively. In such an example, if there is no excess local renewable power, the grid power 16 will effectively be used to charge the auxiliary battery 20 up to the minimum charge threshold C_{T3}, C_{T4}, and at least some further excess local renewable energy up to the set time, t_{S} may still be able to be stored by the auxiliary battery 20, since it will not be full, assuming that the minimum required auxiliary battery charge C_{R} and/or the upper charge threshold C_{U} are less than 100%.

In some examples, more than one of the sub-methods 300, 500, 700, and 900 may be run simultaneously by the processor 22, and any of the minimum charge thresholds, C_{T1}−C_{T4} may be used in the method 100 of FIG. 2, for example the highest minimum charge threshold C_{T}.

It will also be appreciated that, in some examples, the current auxiliary battery charge C_{B} may be too low for the auxiliary battery 20 to be charged up to the minimum required auxiliary battery charge C_{R} or the upper charge threshold C_{U} by the set time t_{S}, even if grid power 16 is continually provided to the auxiliary charger 18 up to the set time t_{S}. In such examples, the system 10 may alert the user that the minimum required auxiliary battery charge C_{R} will not be reached by the set time t_{S}, and/or that the auxiliary battery 20 may require further charging in order to be used for its intended purpose.

The use of the auxiliary battery 20 removes the need for a dedicated energy storage in settings which have local renewable energy sources 14 generating variable levels of power. For example, typical dedicated batteries for storing excess solar energy are able to store in the region of 10-15 kWh. Typical electric car batteries can be in the range of 30 kWh to 200 kWh, such that they are more than large enough to store excess energy generated by a typical domestic home, and could even be used for larger solar or wind installations, such as office spaces which may have large arrays of solar panels, which could be connected to multiple auxiliary chargers for electric car batteries to connect to. Electric bicycle batteries may have a capacity of between 0.5 to 2 kWh, which could also be used instead of a dedicated battery. Many other batteries used in a home environment, or in an office environment may have a combined capacity which is similar to the capacity of a dedicated battery for solar or wind energy systems in a domestic home.

In an uncontrolled system, auxiliary batteries will be charged as quickly as possible whether the energy comes from a renewable source or not. For example, a car battery will be charged using grid power during the night even if there is solar power available during the day. This will happen even if the car is not planned to be used the following day during which the solar power could be used to charge the auxiliary battery at no cost to the consumer.

Therefore, the invention improves efficiency of the renewable energy system because the auxiliary battery 20 is not unnecessarily charged using power from the grid 16, so that it has capacity to charge from further excess power generated by the local renewable power sources 14 at a later stage, whilst ensuring that the auxiliary battery 20 has sufficient power for reliably carrying out its primary function.

Smart electric sockets in a home could also use the method 100, by interconnecting a plurality of smart sockets in a home, each smart socket configured to determine whether an appliance or device which is plugged into the respective socket comprises a battery which requires charging, and the system including the plurality of sockets, each socket being an auxiliary charger 18, and the system performing the method 100 with all of the devices and appliances which have batteries and are connected to the smart sockets.

For all of these examples, the priority schedule and user inputs may be managed by a user from an app on a phone, or may be controlled from a dedicated user interface on, for example, a dedicated charging column such as an electric car charger.

Although the system and method has been described as removing the need for a dedicated energy storage, it can be combined with a dedicated energy storage, to which excess power may be directed if it is not possible to direct power to any auxiliary batteries, for example in block 150.

It will be appreciated that references to receiving historical data and using the historical data to determine a particular value of interest may relate to using machine learning to mine the historical data for improved accuracy.

In the description above, multiple sub-methods for determining a minimum charge threshold have been discussed. The system 10 may be configured to perform only one of these sub-methods, or may be configured to perform multiple of the sub-methods, and to select the most appropriate sub-method, based on user preferences or dynamically determined based on predetermined criteria.

It will also be appreciated that the method may be one of many different modes that a system may be configured to select from, optionally based on user preferences. For example, a system may have, additional to this method, a fast-charging mode, in which the battery is simply charged from whatever power is available as fast as possible and/or an eco-mode in which only excess renewable power is used to the charge the battery, regardless of a minimum charge threshold.

It will further be appreciated that, in some examples, the sub-methods 300, 500, 700, and/or 900, may be part of different modes which a system may be configured to select from.

What is claimed is:

1-9. (canceled)

10. A method of charging an auxiliary battery with a local renewable power source and an external power source, the method comprising:
determining whether there is excess renewable power generated by the local renewable power source, the excess renewable power relating to power which is generated by the local renewable power source, but which is not used by a local power consuming system, and if there is excess renewable power:
directing the excess renewable power to an auxiliary battery charger;
if there is no excess renewable power:
determining a minimum charge threshold based on a predetermined input from a user, the predetermined input from the user relating to one of an upper charge threshold, a minimum required auxiliary battery charge or a minimum amount of charging time required by a set time,
determining whether a minimum charge threshold of the auxiliary battery has been exceeded, and
if the minimum charge threshold has not been exceeded,
directing power from an external power source to the auxiliary battery charger;
wherein determining the minimum charge threshold comprises:
determining expected available excess renewable energy from one or more local renewable power sources up to the set time; and
determining the minimum charge threshold based on the expected available excess renewable energy.

11. The method of claim 10, wherein determining the expected available excess renewable energy comprises:
receiving one of a weather forecast, historical data of excess renewable energy or historical data of weather patterns; and
determining the expected available excess renewable energy from local renewable sources based on the weather forecast, historical data of excess renewable energy or historical data of weather patterns.

12. The method of claim 11, wherein determining the expected available excess renewable energy comprises:
receiving the weather forecast;
determining an expected available renewable energy up to the set time from local renewable power sources based on the weather forecast;
determining an expected energy consumption up to the set time;
offsetting the expected energy consumption from the expected available renewable energy to determine the expected available excess renewable energy up to the set time.

13. The method of claim 10, wherein determining the minimum charge threshold based on the expected available excess renewable energy comprises subtracting the expected available excess renewable energy from an upper charge threshold.

14. The method of claim 10, wherein determining the minimum charge threshold based on the expected available excess renewable energy comprises subtracting the expected available excess renewable energy from the minimum required auxiliary battery charge, or from a charge anticipated to be accumulated over the minimum amount of charging time.

15. The method of claim 10, wherein if the minimum charge threshold has been exceeded, the method comprises not directing power from the external power source to the auxiliary battery charger.

16. The method of claim 10, comprising:
determining whether directing power from an external power source to the auxiliary battery charger continually up to the set time will be sufficient to charge the auxiliary battery up to one of the minimum required auxiliary battery charge, the upper charge threshold, or the minimum amount of charging time required; and
if it is determined that directing power from an external power source to the auxiliary battery charger continually up to the set time will not be sufficient to charge the auxiliary battery up to the respective one of the minimum required auxiliary battery charge, the upper charge threshold or up to the minimum required charging time, alerting the user that they may have insufficient charge by the set time to perform their desired function with the respective auxiliary battery.

17. The method of claim 10, wherein the auxiliary battery is an electric vehicle battery.

18. The method of claim 17, wherein the predetermined input relates to a required travelling distance, and wherein the required travelling distance corresponds to a minimum required auxiliary battery charge.

19. The method of claim 10, further comprising determining if the auxiliary battery has a battery charge exceeding a maximum charge threshold, and if the auxiliary battery charge exceeds the maximum charge threshold, and if there is excess renewable power, directing the excess renewable power to an alternative auxiliary battery based on a priority schedule or back to the grid.

20. The method of claim 10, the method comprising:
if the minimum charge threshold has been exceeded, monitoring an external power price and if the external power price is below a power price threshold:
directing power from the external power source to the auxiliary battery charger; and
if the power price is above the power price threshold:
not directing power from the grid source to the auxiliary battery charger.

21. The method of claim 10, the method comprising:
determining whether power is being drawn from the external power source to power the local power consuming system; and
if power is being drawn from the external power source, and if the minimum charge threshold has been exceeded, drawing power from the auxiliary battery to power the local power consuming system, in preference to the external power source.

22. The method of claim 1, the method comprising:
receiving a priority schedule based on the priority of a plurality of auxiliary batteries, and determining which auxiliary battery to charge based on the priority schedule.

23-33. (canceled)

34. A non-transitory computer readable medium comprising computer-readable instructions that, when read by a computer, causes the performance of a method in accordance the method of claim 10.

35. (canceled)

36. A system for charging an auxiliary battery, the system comprising:
a power distribution unit configured to connect to a local renewable power source and an external power source including a utility grid to receive power; and
an auxiliary charger configured to connect to an auxiliary battery to charge the auxiliary battery, wherein the power distribution unit is connected to the auxiliary charger to selectively direct power to the auxiliary charger; and
a processor and at least one memory comprising computer readable instructions, wherein the processor is configured to read the computer readable instructions, and perform the method according to claim 10.

37. The system according to claim 36, wherein the power distribution unit comprises a plurality of smart sockets, wherein the processor is configured to determine whether a device, plugged into the respective socket, comprises a battery which requires charging, and wherein the processor is configured to perform the method using each socket as a separate auxiliary charger.

38. The system according to claim 36, wherein the auxiliary charger comprises an electric vehicle charger.
